(19) United States
(12) Patent Application Publication
(10) Pub. No.: US 2013/0036746 A1
(43) Pub. Date: Feb. 14, 2013

(54) CERAMIC INTERMITTENTLY SEALABLE REFRACTORY TILE AND CONTROLLED AIR CONTINUOUS GASIFIERS

(71) Applicant: Robert G. Graham, Presque Isle, MI (US)

(72) Inventor: Robert G. Graham, Presque Isle, MI (US)

(21) Appl. No.: 13/654,485

(22) Filed: Oct. 18, 2012

Related U.S. Application Data
(63) Continuation of application No. 12/215,148, filed on Jun. 25, 2008.
(60) Provisional application No. 60/937,310, filed on Jun. 27, 2007.

(51) Int. Cl. F02C 3/28; F27B 7/20; C10B 1/10; F27D 1/10

(52) U.S. Cl. 60/780; 110/323; 110/226; 110/229; 60/39.12

(57) ABSTRACT

High temperature intermittently sealable refractory tile and controlled air continuous gasifiers (rotary kilns) that are manufactured using such refractory tile, waste to energy systems that have such gasifiers as part of the system, and processes in which such waste to energy systems are used, for example, co-generation steam and power plants using biomass as the fuel for the process.

The invention disclosed and claimed herein deals with ceramic intermittently sealable refractory tile and controlled air continuous gasifiers (rotary kilns) that are manufactured using such refractory tile, and waste to energy systems that have such gasifiers as part of the system. The refractory tile and the novel controlled air continuous gasifiers of this invention form part of a system that is novel and environmentally effective to directly convert the latent thermal energy of biomass waste to power (electricity or steam) without the need for costly processes to clean contaminated flue gases.

This application is a utility application claiming priority from U.S. patent application Ser. No. 12/215,148, filed Jun. 25, 2008, pending, which claims priority from U.S. Provisional patent application Ser. No. 60/937,310, filed Jun. 27, 2007, now abandoned.

### BACKGROUND OF THE INVENTION

A rotary kiln is essentially a slow moving, i.e. rotating, refractory-lined steel cylinder. To facilitate the movement of waste material, it generally slants downward from the feed end to the outlet end. The kiln is heated to high temperatures and as material passes through the kiln, waste is evaporated, organic materials are volatized and combustion begins. Generally, rotary kilns can be designed to operate at temperatures between 1400 and 2600 degrees Fahrenheit. The kiln's end product can be either ash or slag, depending on the mode of operation and the initial characteristics of the waste that is fed to the kiln.

Key elements of rotary kiln design are the end seals, drive assembly, kiln refractory and control systems. The end seals are designed to minimize leakage of air into the system and prevent escape of combustion gases. The drive assembly must supply enough torque to rotate the kiln under all operating conditions. The refractory lining (tile) protects the kiln shell from overheating and chemical attack. At the same time, it provides a hot surface to aid in ignition and combustion of waste. Refractory surfaces near the feed inlet are designed for resistance to high impact and thermal shock loads. In the discharge area, refractory must withstand chemical attack and slag penetration.

In the inventive system disclosed and claimed herein using a rotary kiln of this invention, contaminated flue gas from waste combustion is used to heat clean air indirectly in a ceramic heat exchanger to temperatures up to about 2000 degrees Fahrenheit and clean air side pressures up to about 200 psig to run a gas turbine. No flue gas treatment is required, and the gas turbine can discharge clean air for process use rather than combustion products. The novel refractory tiles of this invention allow for the processing of waste without slag buildup and thus this invention eliminates one of the major problems associated with prior art kilns.

The invention herein destroys biomass and related wastes at their source and produces electrical power more efficiently than can be accomplished with conventional steam power plants. The system has low leakage in the heat exchangers used therein, and turbine efficiencies are high owing to the use of controlled maintenance air instead of combustion products.

Plants using the systems disclosed herein can be sized to handle large volume, low heat release, wet materials, at the source, to reduce trucking, storage, and related material handling situations. This process makes it possible for remote communities and industries to destroy municipal solid waste, sludge, wood products and trash and at the same time, generate electricity by firing a gas turbine with clean air.

### THE INVENTION

The invention claimed herein deals with ceramic intermittently sealable refractory tile and controlled air continuous gasifiers that are manufactured using such refractory tile, and waste to energy systems that have such gasifiers as part of the system.

Thus, this invention deals in one embodiment with a ceramic intermittently sealable refractory tile comprising a refractory tile, said refractory tile having a top and a bottom. There is contained within the refractory tile, an air shaft, having an external end and an internal end. The external end is surmounted by a check valve and the internal end opens into a manifold formed in the top of the refractory tile. The manifold has a bottom, there being a plurality of channels from the bottom of the manifold that open through the bottom of the refractory tile.

Unlike the prior art kilns, the kilns of this invention have better control of the air through the fired bed; have customized tuyeres/permeable ceramic plates; eliminates the use of a ceramic ball valve; bears inexpensive construction, and can use standard, off the shelf check valves for safe operation.

It is important that those in the art recognize that the kilns of this invention have a counter-flow air flow pattern over the ash discharge section of the kiln which accomplishes three things that are important. First, the air cools the ash. Secondly, the air preheats the combustion air which it will be noted is introduced below the fuel pile, and thirdly, heated syngas transfers energy to the drying zone refractory lining. All other prior art kilns have an airflow pattern across all three sections of the kiln, which is inefficient.

In another embodiment, there is a ceramic, intermittently sealable refractory tile comprising a refractory tile, wherein the refractory tile is formed of air permeable ceramic. The refractory tile has a top and a bottom, and contained within the refractory tile is an air shaft, having an external end and an internal end. The external end is surmounted by a first manifold; the first manifold has an external end and an internal end. The external end of the manifold is surmounted by a check valve. The manifold internal end surmounts and joins to the external end of the air shaft. The internal end of the air shaft opens into a second manifold formed in the top of the refractory tile.

Yet another embodiment is a ceramic intermittently sealable refractory tile comprising a refractory tile, wherein the refractory tile has a top and a bottom. There is contained within said refractory tile, an air shaft that has an external end and a bifurcated internal end, wherein the external end of the air shaft has surmounted thereon a check valve. The internal ends of the air shaft exit through the bottom of the tile.

Still other embodiments of this invention are a controlled air continuous gasifier containing a plurality of refractory tiles of the type described just Supra and a waste to energy system employing a controlled air continuous gasifier.

Going to yet another embodiment of this invention there is a controlled air, continuous gasifier. The gasifier comprises (i) a cylinder having a feed end and a product end and comprising three zones consisting of zone A, a waste heating zone; zone B, a starved air combustion zone; and zone C, an ash cooling zone.

Component (ii) a feed end cap on the feed end of the cylinder and component (iii) is a product end cap on the product end of the cylinder.

Component (iv) is a product exit port in the product end cap and component (v) a flue gas exit port in the feed end cap.

Component (vi) is a waste feed port in the feed end cap and there is component (vii) which is at least one air injection port near the product end cap, the air injection port joining with an air manifold, wherein the air manifold is located outside any ceramic refractory tile of zones B and C and terminates at an upper end of Zone B.

Component (viii) is a means for allowing rotation of the gasifier. The cylinder comprises a. a refractory lined open center core running essentially the full length of the cylinder. The refractory lining has an inside surface and an outside surface; b. a first metal shell covering the entire outside surface of the refractory lining, the first metal shell having an outside surface; c. an insulated second metal shell formed adjacent to, and conforming to, the outside surface configuration of the first metal shell such that there is a hollow core provided between the first metal shell and the second metal shell, wherein the refractory lining of zone B is a ceramic sealable refractory tile as set forth just Supra.

Another embodiment of this invention is a waste to energy system comprising in combination at least a. a gasifier as described just Supra, b. an oxidizer; c. an air to air, all-ceramic heat exchanger; d. a gas turbine; e. a generator operated from the gas turbine and f. a filter and compressor driven by the gas turbine.

Yet another embodiment of this invention is a waste to energy system comprising in combination at least: a. a gasifier as disclosed just Supra; b. an oxidizer; c. an air to air, all-ceramic heat exchanger; d. a high pressure, medium temperature, alloy metal air-to air heat exchanger; e. a gas turbine; f. a generator operated from the gas turbine; and g. a filter and compressor driven by the gas turbine.

### BRIEF DESCRIPTION OF THE DRAWINGS

FIG. 1 is a full top view of a gasifier of this invention.

FIG. 2 is a cross sectional view of FIG. 1, taken through the line 2-2 of FIG. 1.

FIG. 3 is an elevation of the feed end of a gasifier of this invention with the end cap removed.

FIG. 4 is a side view of a tile 25A of this invention.

FIG. 5 is a cross sectional view of the tile of FIG. 4.

FIG. 6 is a view in perspective of the ceramic portion of the tile of FIG. 4, showing the exit ports of the air channels.

FIG. 7 is a side view of a tile 25B of this invention.

FIG. 8 is a cross sectional view of the tile of FIG. 7 showing the bifurcated exit ports.

FIG. 9 is a side view of a tile 25C of this invention.

FIG. 10 is a full top view of an array of the tile of FIG. 9 being fed air using a common manifold.

FIG. 11 is a side view of the array of FIG. 10.

FIG. 12 is a cross sectional side view through the center line of a check value useful in this invention.

FIG. 13 is a full side view of the tile of 9 wherein the tile has been mounted on standard fire brick.

FIG. 14 is a side view of a tile of this invention in which its position in the rotation is just after arriving at point E in FIG. 3, wherein the valve 26 is closed.

FIG. 15 is a side view of the tile of FIG. 14 in which its position in the rotations is just after arriving at Point D in FIG. 3, wherein the valve 26 is fully open.

FIG. 16 is a bio-solids thermal conversion graph that was generated by the actual operation of a waste to energy system of this invention.

### DETAILED DESCRIPTION OF THE DRAWINGS

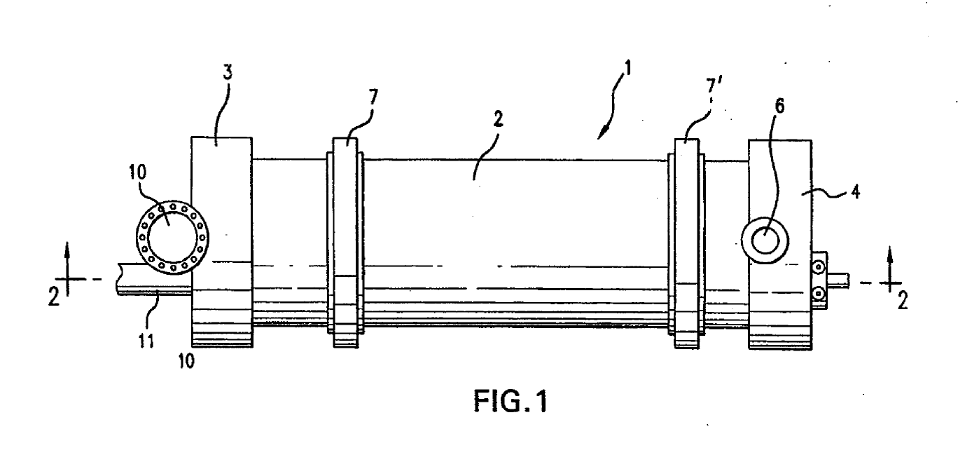

Turning now to the Figures, there is shown in FIG. 1, a top view of a gasifier 1 of this invention. There is shown a cylindrical element 2, which is generally an insulated metal shell. Also shown are the feed end cap 3 and the product end cap 4, along with an air and syngas exit port 5, ignitions and stabilization burner 36, ash auger 37, air manifold 38 and an air inlet port 6. Shown at each end of the cylindrical element 2 are the rotating means 7 and 7′.

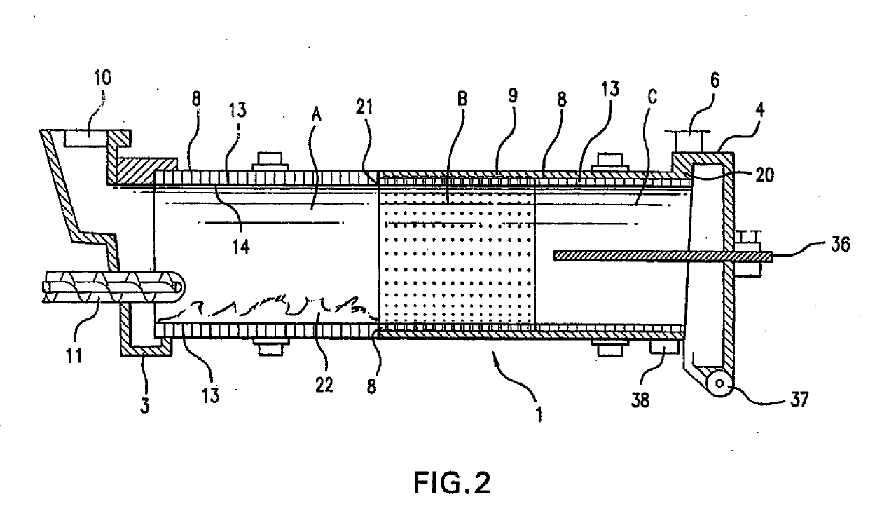

With reference to FIG. 2, there is shown a cross sectional view of the gasifier 1 of FIG. 1 through line 2-2 wherein there is shown the feed end cap 3, the product end cap 4, the air inlet port 6, the refractory lining 8, the air conduction system 9, and, three zones designated A, B, and C, which will be discussed infra. Further shown in the feed cap 3 are the flue gas exit port 10 and the waste feed port 11.

With regard to FIG. 2, zone A is a preheat and waste heating zone and does not require the refractory tiles of the instant invention and therefore, the refractory lining in this zone can be standard refractory tiles 13. However, it is contemplated that the tiles of this invention can also be used if the particular process required them to be in that zone. This zone constitutes on the order of about twenty percent of the interior volume of the cylindrical element 2.

The feed enters this solid, refractory-lined zone that contains no air-cooling. The syngas from the combustion process contains primarily methane, hydrogen, carbon monoxide, carbon dioxide and water at a temperature below 700 dF. As this mixture passes over the feed, it drives off water, distills volatiles and heats the refractory in the preheat zone.

In addition, there is shown zone B, which is the starved air combustion zone, which constitutes on the order of about sixty to seventy percent of the interior volume of the cylindrical element 2. A percentage of the stoichiometric air is injected through the tuyeres into the fuel bed and combusts the fixed carbon to carbon monoxide. The rotation of the bed through the fuel introduces air continuously into the fuel as new fuel gently tumbles across the tuyeres as it moves downward to the exit. Because zone B is the combustion zone, this zone should be lined with a multiplicity of the inventive tiles of this invention.

Zone C is the ash cooling zone and this constitutes on the order of about twenty percent of the total interior volume of the cylindrical element 2. The air from the ash discharge housing bustle is introduced between the outer skin and the kiln shell at the ash housing. This air passes around the thin refractory-line kiln section and cools the ash indirectly as it passes over the kiln shell up to the combustion zone. Since this zone is not a combustion zone, the lack of direct air through the inventive tile 23 is acceptable, and thus, one need not provide this zone with a refractory tile of this invention and one can use standard tile 13 in this zone. However, as above, the particular process may require the use of the inventive tile of this invention in this zone and such a use is contemplated within the scope of this invention.

The above-described arrangement is the direct opposite arrangement of the gasifier and process described in U.S. Pat. No. 6,381,963, In that design, the air starts at the preheat zone and flows into the combustion zone, and continues on through the ash zone. Therefore, it cools the preheat zone and heats the ash zone using energy that it picked up from the entire length of the kiln as it travels from the feed end to the ash discharge housing. In the inventive process, the air is introduced at the ash discharge housing and taken off before it reaches the preheat zone.

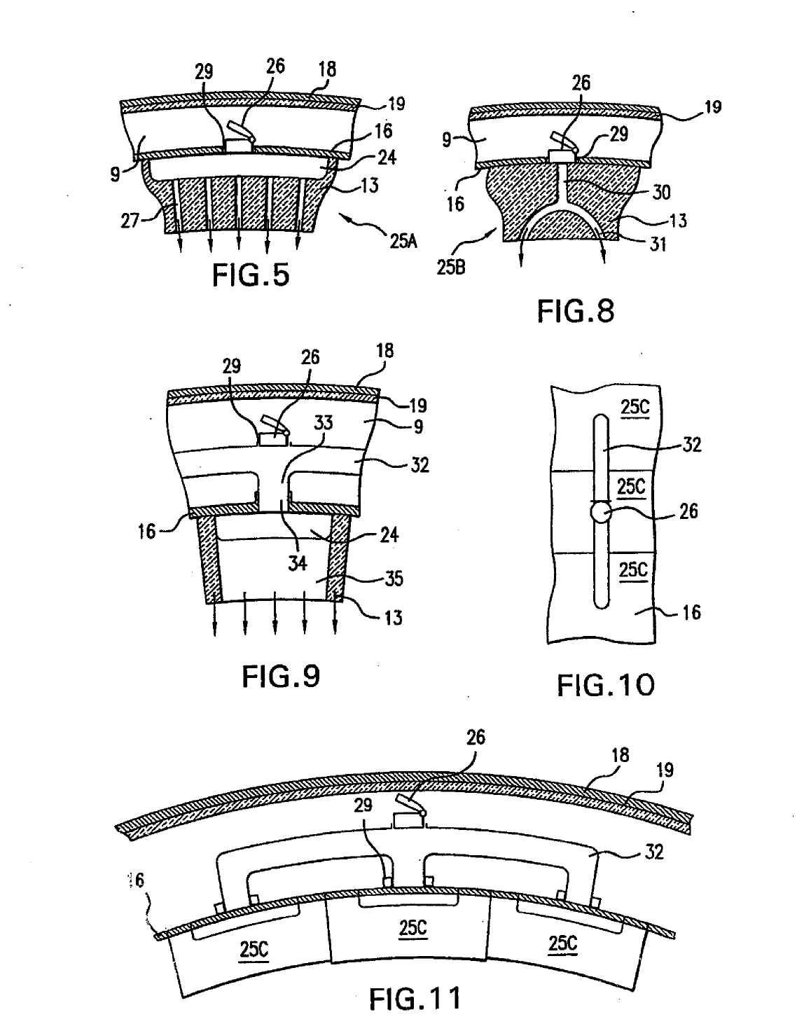

Thus, it is contemplated within the scope of this invention to use a multiplicity of the inventive tile in the refractory lining 8 in combination with standard tile 13, and it is also contemplated within the scope of this invention to provide for the whole of zone B to be made up of the inventive tile. The designation 13 denotes standard fire brick, but is also used to shown standard fire brick construction material, such as in FIGS. 5, 8 and 9.

During processing, air is introduced into the air conduction system 9, and the air is allowed to move through the air conduction system 9. However, a certain portion of the air is conducted to zone B, wherein it moves into the inventive refractory tiles through open air shafts, all of which will be discussed infra. The movement of the air in this manner differs from some of the prior art, in which air is introduced directly into the cylindrical element 2 through the product end cap 4, and directly into the combustion zone B and on through the zone A and out the exit 5.

When air is introduced as stated in the prior art. The method is ineffective in that a lot of the air moves through the gasifier and exits with the flue gas and is lost. Also, the control of combustion is difficult in that the air is not moved to the combustion mass in a constant and consistent manner such that the rate that each portion of the combusting mass uses is inconsistent and therefore, the combustion is inconsistent and permits the huge build up of slag. Removing the slag is a major problem and often leads to a clogged gasifier and provides other major problems, including a large amount of ash that has to be collected and handled.

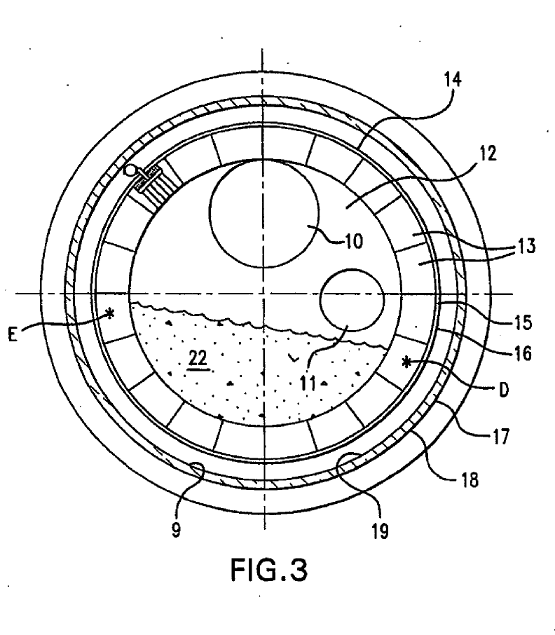

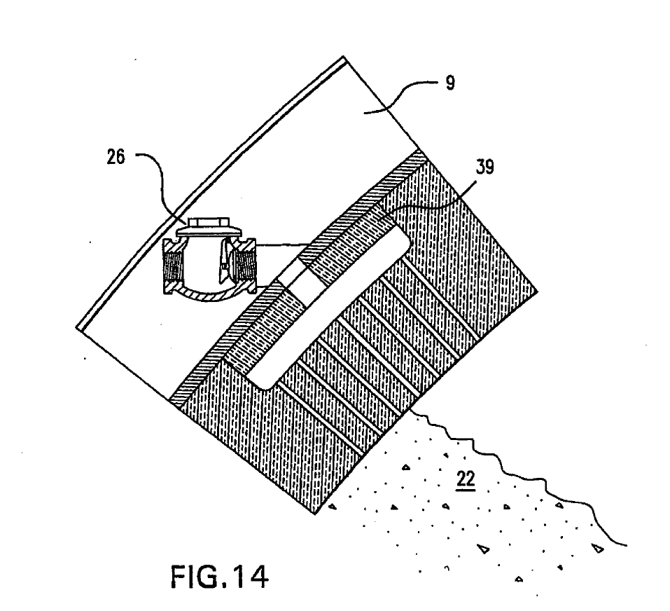

FIG. 14 is a side view of a tile of this invention in which its position in the rotation is just after arriving at point E in FIG. 3, wherein the valve 26 is closed. Number 39 denotes insulation as an option on the tile.

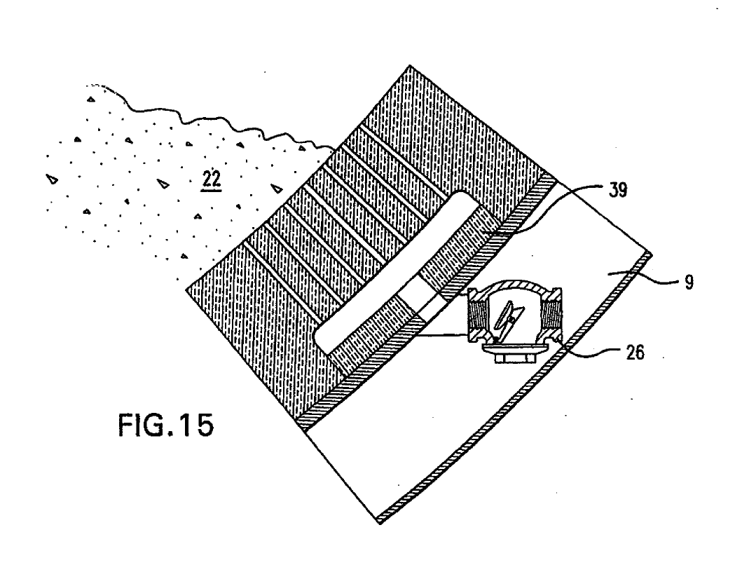

FIG. 15 is a side view of the tile of FIG. 14 after it has arrived at about point D on FIG. 3, wherein the valve 26 is open allowing air to flow from the air conduction duct 9 into the fire bed in zone B.

It should be noted by those with ordinary skill in the art, that the gasifier is normally tilted such that the feed end of the gasifier is higher than the product end. This is to facilitate the movement of the waste through the gasifier 1 as the gasifier 1 rotates during operation. Normal rotation for a gasifier is clockwise.

Turning now to FIG. 3, which is an elevation of the feed end of the gasifier 1. Shown is the hollow core 12, which is formed by the placement of the standard refractory tiles 13 to form the standard refractory lining 14. Positioned on the outer surface 15 of the standard refractory lining 14 is a first metal shell 16, which provides the integrity to hold the refractory lining 14 together and in place. It should be understood at this point that the elevation does not show the refractory lining 8 containing the inventive tiles 25A, 25B, and 25C and such illustration can be found, for example, in FIGS. 3,

There is a second metal shell 17, which is a metal cover 18 over insulation 19 over the entire cylindrical portion 2 of the gasifier 1. The placement of the first metal shell 16 and the second metal shell 17 is such that a hollow air conduction system 9 is formed essentially from the tail end of zone C (point 20) to the leading edge (top) of zone B (point 21), wherein zone B is bustled at point 21 to prevent the transfer of any air into the feed area in zone A (see FIG. 2).

Zone B is the preferred zone for the use of the inventive tiles herein although, it is contemplated within the scope of this invention to use the inventive tile 25 A-C in zones A and C as well, depending on the type of waste that is being processed, among other factors. It has been found that inventive tile 25A is best when processing litter such as biomass litter; tile 25B is best when processing municipal solid waste, and tile 25 C is best used when processing sludge such as sewage sludge, and the like.

There is shown a certain amount of waste matter 22 in the bottom of the gasifier 1 in zone A that is being processed. As will be discussed infra, the valves 26 of the sealable tiles 25 A-C of this invention open when the tiles 25 A-C arrive at approximately point D, shown on FIG. 3, during the clockwise rotation of the gasifier, and the valves 26 close when the tiles 25 A-C arrive at approximately Point E, also shown on FIG. 3. This means that the air is moved to and circulated intimately with the waste during rotation from point D to point E in zone B, and then the valves 26 stay closed cutting off air supply through the upper most valves 26 until the valves 26 rotate through and again arrive at point D. The valves 26, in combination with the air pressure behind them also operate to prevent air and flue gas from returning to the air conduction system 9. In this manner there is a continuous, controlled flow of air through just the waste 22 that is being combusted.

Preferred for this invention are refractory tiles 25 A-C that are put together using two halves. Thus, when the tiles are molded from ceramics, they are usually molded in halves and joined together by mortar to form the whole tile 25A, 25B or 25C.

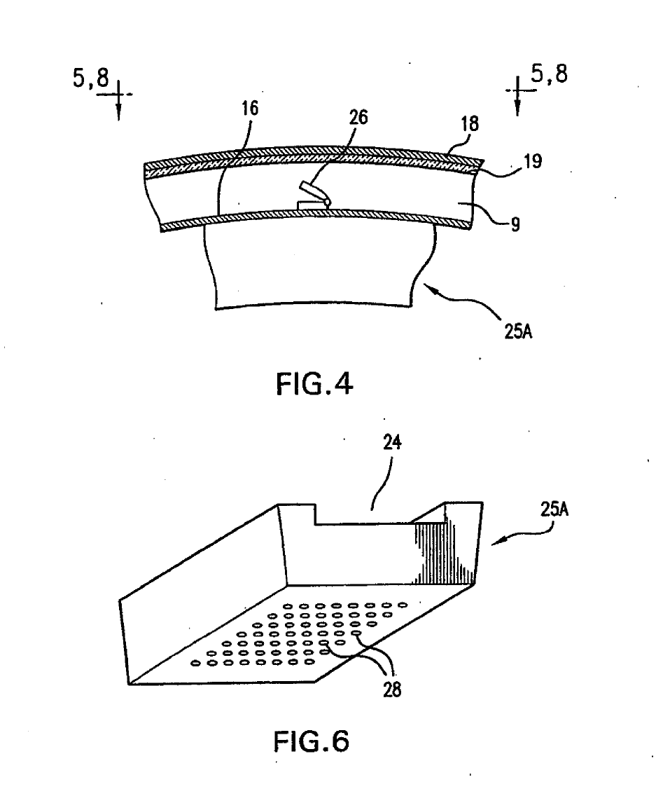

Turning to FIG. 4, which is a view into the gasifier 1, zone B, showing a side view of a molded tile 25A of this invention positioned in a portion of the gasifier 1, wherein there is shown the first steel cover 16, a check valve 26, an air manifold 24 built right into the tile 25A, wherein the tile is constructed from hard ceramic brick, the second outer steel shell 18, and insulation 19.

Turning now to FIG. 5, there is shown a cross sectional view of the tile of FIG. 4 through line 5-5 showing channels 27 through which the air passes from the air conduction duct 9 to the interior of zone B of the gasifier 1 through air shaft 29. FIG. 6 is a view in perspective of the tile 25A per se showing the multiple exit ports 28 through the tile 25A, and the manifold 24.

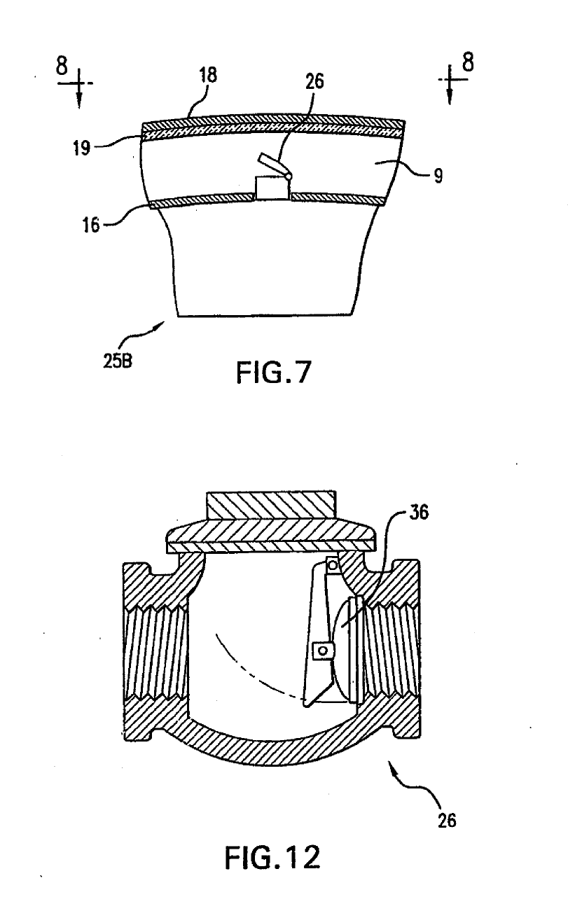

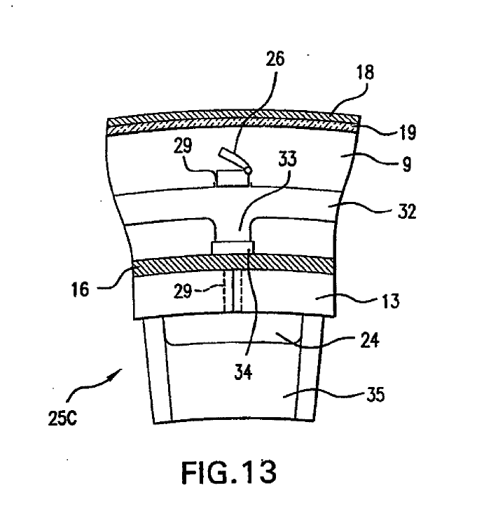

Turning now to FIG. 7, wherein there is shown a second embodiment of the inventive tile of this invention, 25B positioned in a portion of a gasifier 1. Shown therein is a side view of the tile 25B, the first steel cover 16, a check valve 26, and insulation 19. FIG. 8 shows a cross sectional view of FIG. 4 through line 8-8 showing the first steel cover 16, a check valve 26, surmounted on the steel 16 and through air shaft 29, air shaft 30 in the tile per se, and the bifurcated shaft 30 showing exit ports 31.

Turning now to a third embodiment of the inventive tile herein, there is shown in FIG. 9, an inventive tile 25C that is comprised of the first steel cover 16, a check valve 26, an first air manifold 32 that is constructed in the air conduction duct 9 which has an exit port 33 that inserts into an air shaft 29, wherein the tile is constructed from standard hard ceramic brick 13, the second outer steel shell 18, insulation 19, air conduction duct 9, a second air manifold 24 in the tile per se, an air shaft 29 into the tile 25C, and an entry port 34 into the manifold 24.

The tile 25C is constructed of air permeable ceramic 35 in the core. This tile is intended to be used in conjunction with several other tiles sharing one common air manifold 32 as is shown in FIG. 10 which is a top view of the tile inside the steel shell 18 and the insulation 19. A side view of FIG. 10 is shown in FIG. 11 without the steel shell 18 and the insulation 19 in place. It should be noted that the permeable ceramic 35 is only in the core of the tile 25C and that it is surrounded by standard fire brick 13.

FIG. 12 is a full side cross sectional view through the center of the valve 26 that is useful in this invention although the inventor herein does not wish to be held to just that valve, as any check valve will suffice for this invention, as long as it will automatically open when needed and automatically close when needed according to the rotation of the gasifier as described Supra. This valve is a commercially available eclipse disc type check valve available from Eclipse Combustion, Don Mills Ontario, Canada. Note the flapper 36 cased inside of the valve that allow the valve 26 to be a check valve.

In addition to the advantage obtained by the use of the valve control of air, there is also another feature that adds to the efficiency of the unit.

It should be noted that tuyeres or jet nozzles can be used on the exit ports of the tiles of this invention and it is contemplated within the scope of this invention to equip the tiles with such tuyeres and jet nozzles, depending on the type of material being combusted. For purposes of this invention, jets and nozzles as used herein means those shown in “Engineers' Illustrated Thesaurus, by Herkimer, H., Wm. Penn Publishing Corp., New York, N.Y., Chemical Publishing Co., Inc. pages 348 and 349, wherein there is shown a multiplicity of nozzles and jets, it being understood that the criticality of the nozzle herein is that the air delivery system of this invention is a blast tuyere and is not a single point of exit from the air shaft, reference is made to jet E, blast tuyere and jet A, Rose jet for spreading.

The tiles of this invention are made from silicon carbide/nitride. They are easily cleaned, they are hard and ash releases from them readily. The refractory core is therefore easy to build, and is easily retrofitted.

For purposes of this invention, waste to energy systems are those set forth in U.S. Pat. No.6,381,963, that issued May 7, 2002 to the inventor herein and such waste to energy systems, their individual components, make up, use and control are incorporated herein for what is taught about such systems.

Another embodiment of this invention is the torrefaction of biomass to useful burnable materials, such as charcoal. Torrefaction is a mild form of pyrolysis at temperatures' typically ranging between 200 to 320° C., even though such torrefaction can be carried out at higher temperatures, depending on what the end product is designed to be.

It has been found that the waste to energy systems of this invention can provide torrefied product that is useful for burning in furnaces and the like.

Waste can be defined as any material made up of one of the following components: water, non-combustible ash, fixed carbon and compounds that break down into volatile organic compounds (VOC's) in the presence of temperatures above 200° F., but in all cases, the waste must contain at least VOC's and fixed carbon.

The first event during the waste to energy conversion is the removal of moisture from the waste mass. Then, the second phase is the removal of very volatile, semi-volatile, and volatile materials by an increase in heat in the vessel. The next stage is the carbon reduction and oxidation phase, and the remaining phase is the ash stage at which time the materials are normally removed from the vessel.

This embodiment of the invention is the removal of the torrified product after about 30 to about 90 percent of the very volatile, semi-volatile, and volatile materials have been removed and some carbon reduction and oxidation has taken place.

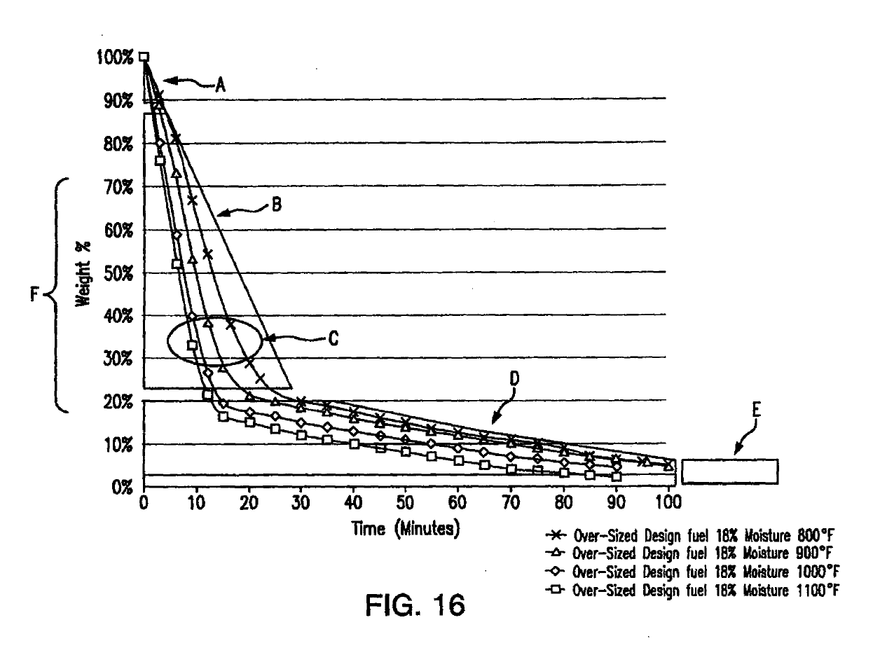

FIG. 16 is a bio-solids thermal conversion graph that was generated by the actual operation of a waste to energy system of this invention.

The various zones of the graph have been configured by outlines to show zones A, B, C, D, E, and F. Zone A is the moisture removal zone. Zone B is the removal of very volatile, semi-volatile, and volatile materials from the biomass and zone C notes the zone in which the curves will move to the right as the reaction temperature decreases.

Zone D is the carbon reduction and oxidation zone, zone E is the ash zone and section F shows the point at which desired materials are torrefied to a greater or lesser degree and can be removed from the system by stopping the operations of the waste to energy system. A preferred product is the stopping of the operation at the point designated by the large asterisk.

The X line of the graph is the over-sized design fuel 18% moisture at 700° F.; the pyramid line is the over-sized design fuel 18% moisture at 900° F.; the diamond line is the oversized design fuel 18% moisture at 1000° F., and the square line is the over-sized design fuel 18% moisture at 1100° F.

What is claimed is:

1. A ceramic, intermittently sealable refractory tile comprising a refractory tile, said refractory tile having a top and a bottom, and contained within said refractory tile, an air shaft, having an external end and an internal end, said external end being surmounted by a check valve, said internal end opening into a manifold formed in the top of the refractory tile, said manifold having a bottom, there being a plurality of channels from the bottom of the manifold and opening through the bottom of the refractory tile.

2. A ceramic, intermittently sealable refractory tile comprising a refractory tile, said refractory tile being formed of air permeable ceramic, said refractory tile having a top and a bottom, and contained within said refractory tile, an air shaft, having an external end and an internal end, said external end being surmounted by a first manifold, said first manifold having an external end and an internal end, said manifold external end being surmounted by a check valve, said manifold internal end surmounting and joined to the external end of the air shaft, said internal end of the air shaft opening into a manifold formed in the top of the refractory tile.

3. A ceramic intermittently sealable refractory tile comprising a refractory tile, said refractory tile having a top and a bottom and contained within said refractory tile, an air shaft, having an external end and a bifurcated internal end, the external end of the air shaft having surmounted thereon a check valve, the internal ends of the air shaft exiting through the bottom of the tile.

4. A controlled air continuous gasifier containing a plurality of refractory tile of claim 1.

5. A controlled air continuous gasifier containing a plurality of refractory tile of claim 2.

6. A controlled air continuous gasifier containing a plurality of refractory tile of claim 3.

7. A waste to energy system employing a controlled air continuous gasifier as claimed in claim 4.

8. A waste to energy system employing a controlled air continuous gasifier as claimed in claim 5.

9. A waste to energy system employing a controlled air continuous gasifier as claimed in claim 6.

10. A controlled air, continuous gasifier, said gasifier comprising:
(i) a cylinder having a feed end and a product end and comprising three zones consisting of zone A, a waste heating zone;
zone B, a starved air combustion zone; and zone C, an ash cooling zone;
(ii) a feed end cap on the feed end of the cylinder;
(iii) a product end cap on the product end of the cylinder:
(iv) a product exit port in the product end cap;
(v) a flue gas exit port in the feed end cap;
(vi) a waste feed port in the feed end cap:
(vii) at least one air injection port near the product end cap, said air injection port joining with an air manifold, said air manifold located outside any ceramic refractory tile of zones B and C and terminating at an upper end of Zone B;
(viii) a means for allowing rotation of the gasifier,
wherein the cylinder comprises:
a. a refractory lined open center core running essentially the full length of the cylinder, said refractory lining having an inside surface and an outside surface;
b. a first metal shell covering the entire outside surface of the refractory lining, said first metal shell having an outside surface;
c. an insulated second metal shell formed adjacent to, and conforming to, the outside surface configuration of the first metal shell such that there is a hollow core provided between the first metal shell and the second metal shell, wherein, the refractory lining of zone B is a ceramic sealable refractory tile as claimed in claim 1.

11. A controlled air, continuous gasifier, said gasifier comprising:
(i) a cylinder having a feed end and a product end and comprising three zones consisting of zone A, a waste heating zone; zone B, a starved air combustion zone; and zone C, an ash cooling zone;
(ii) a feed end cap on the feed end of the cylinder;
(iii) a product end cap on the product end of the cylinder:
(iv) a product exit port in the product end cap;
(v) a flue gas exit port in the feed end cap;
(vi) a waste feed port in the feed end cap:
(vii) at least one air injection port near the product end cap, said air injection port joining with an air manifold, said air manifold located outside any ceramic refractory tile of zones B and C and terminating at an upper end of Zone B;
(viii) a means for allowing rotation of the gasifier,
wherein the cylinder comprises:
a. a refractory lined open center core running essentially the full length of the cylinder, said refractory lining having an inside surface and an outside surface;
b. a first metal shell covering the entire outside surface of the refractory lining, said first metal shell having an outside surface;
c. an insulated second metal shell formed adjacent to, and conforming to, the outside surface configuration of the first metal shell such that there is a hollow core provided between the first metal shell and the second metal shell, wherein, the refractory lining of zone B is a ceramic sealable refractory tile as claimed in claim 2.

12. A controlled air, continuous gasifier, said gasifier comprising:
(i) a cylinder having a feed end and a product end and comprising three zones consisting of zone A, a waste heating zone;
zone B, a starved air combustion zone; and zone C, an ash cooling zone;
(ii) a feed end cap on the feed end of the cylinder;
(iii) a product end cap on the product end of the cylinder:
(iv) a product exit port in the product end cap;
(v) a flue gas exit port in the feed end cap;
(vi) a waste feed port in the feed end cap:
(vii) at least one air injection port near the product end cap, said air injection port joining with an air manifold, said air manifold located outside any ceramic refractory tile of zones B and C and terminating at an upper end of Zone B;
(viii) a means for allowing rotation of the gasifier,
wherein the cylinder comprises:
a. a refractory lined open center core running essentially the full length of the cylinder, said refractory lining having an inside surface and an outside surface;
b. a first metal shell covering the entire outside surface of the refractory lining, said first metal shell having an outside surface;
c. an insulated second metal shell formed adjacent to, and conforming to, the outside surface configuration of the first metal shell such that there is a hollow core provided between the first metal shell and the second metal shell, wherein, the refractory lining of zone B is a ceramic sealable refractory tile as claimed in claim 3.

13. A waste to energy system comprising in combination at least:
a. a gasifier of claim 10;
b. an oxidizer;
c. an air to air, all-ceramic heat exchanger;
d. a gas turbine;
e. a generator operated from the gas turbine;
f. a filter and compressor driven by the gas turbine.

14. A waste to energy system comprising in combination at least:
a. a gasifier of claim 11;
b. an oxidizer;
c. an air to air, all-ceramic heat exchanger;
d. a gas turbine;
e. a generator operated from the gas turbine;
f. a filter and compressor driven by the gas turbine.

15. A waste to energy system comprising in combination at least:
a. a gasifier of claim 12;
b. an oxidizer;
c. an air to air, all-ceramic heat exchanger;
d. a gas turbine;
e. a generator operated from the gas turbine;
f. a filter and compressor driven by the gas turbine.

16. A waste to energy system comprising in combination at least:
a. a gasifier of claim 10;
b. an oxidizer;
c. an air to air, all-ceramic heat exchanger;
d. a high pressure, medium temperature, alloy metal air-to air heat exchanger;
e. a gas turbine;
f. a generator operated from the gas turbine;
g. a filter and compressor driven by the gas turbine.

17. A waste to energy system comprising in combination at least:
a. a gasifier of claim 11;
b. an oxidizer;
c. an air to air, all-ceramic heat exchanger;
d. a high pressure, medium temperature, alloy metal air-to air heat exchanger;
e. a gas turbine;
f. a generator operated from the gas turbine;
g. a filter and compressor driven by the gas turbine.

18. A waste to energy system comprising in combination at least:
a. a gasifier of claim 12;
b. an oxidizer;
c. an air to air, all-ceramic heat exchanger;
d. a high pressure, medium temperature, alloy metal air-to air heat exchanger;
e. a gas turbine;
f. a generator operated from the gas turbine;
g. a filter and compressor driven by the gas turbine.

19. A method of producing a useful product from waste, the method comprising;
providing a waste feedstock;
providing a waste to energy system as claimed in claim 13;
feeding the waste feedstock into the waste to energy gasifier;
heating the gasifier and waste feed stock to at least 700° F. for a sufficient period of time to produce a torrefied product;
removing the torrefied product from the gasifier.

20. A torrefied product when produced by the method of claim 19.

21. A method of producing a useful product form waste, the method comprising;
providing a waste feedstock;
providing a waste to energy system as claimed in claim 14;
feeding the waste feedstock into the waste to energy gasifier;
heating the gasifier and waste feed stock to at least 700° F. for a sufficient period of time to produce a torrefied product;
removing the torrefied product from the gasifier.

22. A torrefied product when produced by the method of claim 21.

23. A method of producing a useful product form waste, the method comprising;
providing a waste feedstock;
providing a waste to energy system as claimed in claim 15;
feeding the waste feedstock into the waste to energy gasifier;
heating the gasifier and waste feed stock to at least 700° F. for a sufficient period of time to produce a torrefied product;
removing the torrefied product from the gasifier.

24. A torrefied product when produced by the method of claim 23.

25. A method of producing a useful product form waste, the method comprising;
providing a waste feedstock;
providing a waste to energy system as claimed in claim 16;
feeding the waste feedstock into the waste to energy gasifier;
heating the gasifier and waste feed stock to at least 700° F. for a sufficient period of time to produce a torrefied product;
removing the torrefied product from the gasifier.

26. A torrefied product when produced by the method of claim 25.

27. A method of producing a useful product form waste, the method comprising;
providing a waste feedstock;
providing a waste to energy system as claimed in claim 17;
feeding the waste feedstock into the waste to energy gasifier;
heating the gasifier and waste feed stock to at least 700° F. for a sufficient period of time to produce a torrefied product;
removing the torrefied product from the gasifier.

28. A torrefied product when produced by the method of claim 27.

29. A method of producing a useful product form waste, the method comprising;
providing a waste feedstock;
providing a waste to energy system as claimed in claim 18;
feeding the waste feedstock into the waste to energy gasifier;
heating the gasifier and waste feed stock to at least 700° F. for a sufficient period of time to produce a torrefied product;
removing the torrefied product from the gasifier.

30. A torrefied product when produced by the method of claim 29.
